(19) United States
(12) Patent Application Publication
(10) Pub. No.: US 2008/0222895 A1
(43) Pub. Date: Sep. 18, 2008

(54) KNIFE WITH WINDOW BREAKER

(75) Inventors: Anthony L. Marfione, Bradford, PA (US); Anthony G. Marfione, Bradford, PA (US)

Correspondence Address: FAY SHARPE LLP, 1100 SUPERIOR AVENUE, SEVENTH FLOOR, CLEVELAND, OH, 44114, US

(73) Assignee: MICROTECH KNIVES, INC., Bradford, PA (US)

(21) Appl. No.: 11/684,896

(22) Filed: Mar. 12, 2007

(51) Int. Cl. B26B 11/00

(52) U.S. Cl. 30/151

(57) ABSTRACT

A knife having a thin handle and a window breaker is disclosed. The handle comprises a frame and a cover. The frame has an arch and a threaded bore for supporting the window breaker is at least partially located within the arch. The cover has a support wall into which the arch fits. The threaded bore has a diameter sufficiently large that the structural integrity of the arch may be compromised without support from the support wall when the window breaker is screwed in and used.

### BACKGROUND

Knives that have blades which move from a safety position to a unsheathed use position are well known. They can be broadly classified into two types, depending on the movement between the positions. In a slide knife, the blade slides from a sheathed position, usually inside the handle of the knife, to an exposed use position out the front of the handle. Some operating mechanisms for slide knives are described in U.S. Pat. Nos. 5,819,414, and 6,085,423, which are hereby fully incorporated by reference. In a folding knife, the blade pivots about an axis normal to a common plane of the handle and blade between a sheathed position within the handle through an arc to a use position external of the handle. A lock then prevents the blade from pivoting on the axis during use.

New knife designs have very thin handles. For example, the TROODON knife made by Microtech Knives has a maximum width of 0.435 inches. Because the blade must still fit within the handle, the components that make up the handle must be even thinner.

It is desirable to provide a window breaker on a knife. A window breaker is a conical metallic piece, normally aluminum, with a carbide insert at its tip, The window breaker is used to forcefully strike a glass window, such as a car window, to break it. A large amount of pressure is required to break such glass. Because of this high impact requirement, the window breaker must be provided with a robust connection to the knife. This robust connection is provided by a threaded mounting stud which mounts into a threaded bore in the knife. However, because the knife handle is so thin, it is difficult to provide a threaded bore of sufficient diameter to provide adequate support for the window breaker without compromising the structural integrity of the threaded bore.

### BRIEF DESCRIPTION

Disclosed herein, in various embodiments, is a knife with a thin handle that can support a window breaker. The knife comprises a blade, a handle, and a window breaker. The knife handle comprises two pieces, a frame and a cover. The frame comprises a sidewall and a second wall perpendicular to the sidewall. The second wall has an arch extending away from the sidewall. A threaded bore runs through the second wall and is at least partially located within the arch. The cover comprises a sidewall and a support wall. The support wall has a recess into which the arch fits when the frame and cover are fitted together. The window breaker comprises a tip and a threaded stud. The tip is made from a material harder than glass, such as carbide. The threaded stud is used to mount the window breaker in the threaded bore.

The knife may further comprise a fastener system to attach the frame and cover of the handle together.

In specific embodiments, the second wall forms the rear end of the knife handle so that the window breaker is mounted on the back of the knife.

In specific embodiments, the handle has a total thickness of at most 1.0 inch.

In further embodiments, the threaded bore may have a diameter, not including the threads, of from about 0.120 inches to about 0.150 inches.

In further embodiments, the threaded bore may have a diameter, including the threads, of from about 0.180 inches to about 0.200 inches.

In further embodiments, the ratio of the threaded bore, not including the threads, to the width of the second wall, may be from about 0.55 to about 0.65.

In other embodiments, the second wall has a base width from the bore to an outer edge of the frame and an arch width from the bore to the tip of the arch (furthest from the outer edge). The ratio of the arch width to the base width may be from about 0.40 to about 0.70.

The knife may be a slide knife or a folding knife.

In another embodiment, the knife comprises a blade, a handle, and a window breaker. The knife handle comprises two pieces, a frame and a cover. The frame comprises a sidewall, a second wall perpendicular to the sidewall, and a threaded bore running through the second wall. The cover comprises a sidewall and a support wall. The support wall interfaces with the second wall. The threaded bore has a diameter sufficiently large such that the structural integrity of the second wall is compromised without the support of the support wall. The window breaker comprises a tip and a threaded stud. The tip is made from a material harder than glass, such as carbide. The threaded stud is used to mount the window breaker in the threaded bore.

In a further embodiment, the second wall has a width, and the ratio of the bore diameter to the second wall width is from about 0.55 to about 0.65.

A method for forming a thin arch on a wall of a knife is also provided.

These and other features of the present disclosure are further described herein.

### BRIEF DESCRIPTION OF THE DRAWINGS

The following is a brief description of the drawings, which are presented for the purposes of illustrating the exemplary embodiments disclosed herein, not for limiting them.

FIG. 1 is a view of an exemplary embodiment of the knife with a window breaker.

FIG. 2 is a side view of the frame of the knife handle.

FIG. 3 is a top view of the frame of the knife handle.

FIG. 4 is a cross-sectional view of the frame of the knife handle looking towards the rear of the frame from line A-A of FIG. 2.

FIG. 5 is a rear view of a first step in making a thin arch on the handle frame.

FIG. 6 is a rear view of an intermediate step in making a thin arch on the handle frame.

FIG. 7 is a rear view of the handle frame.

FIG. 8 is a side view of the handle cover,

FIG. 9 is a rear view of the handle cover,

FIG. 10 is a rear view of the knife handle, with frame and cover assembled.

FIG. 11 is a side view of the window breaker.

### DETAILED DESCRIPTION

A more complete understanding of the knives and components disclosed herein can be obtained by reference to the accompanying Figures. These Figures are merely schematic representations based on convenience and the ease of demonstrating the present development and are, therefore, not intended to indicate relative size, dimensions, or location of the devices or components thereof and/or to define or limit the scope of the exemplary embodiments. Although specific terms are used in the following description for the sake of clarity, these terms are intended to refer only to the particular structure of the embodiments selected for illustration in the Figures and are not intended to define or limit the scope of the disclosure. In the Figures and the following description below, it is to be understood that like numeric designations refer to components of like function.

FIG. 1 is a view of an exemplary embodiment of the knife with a window breaker. The knife 10 comprises a blade 20, a handle 30, and a window breaker 40. The knife 10 is a slide knife. Here, the handle 30 is shown in an assembled condition.

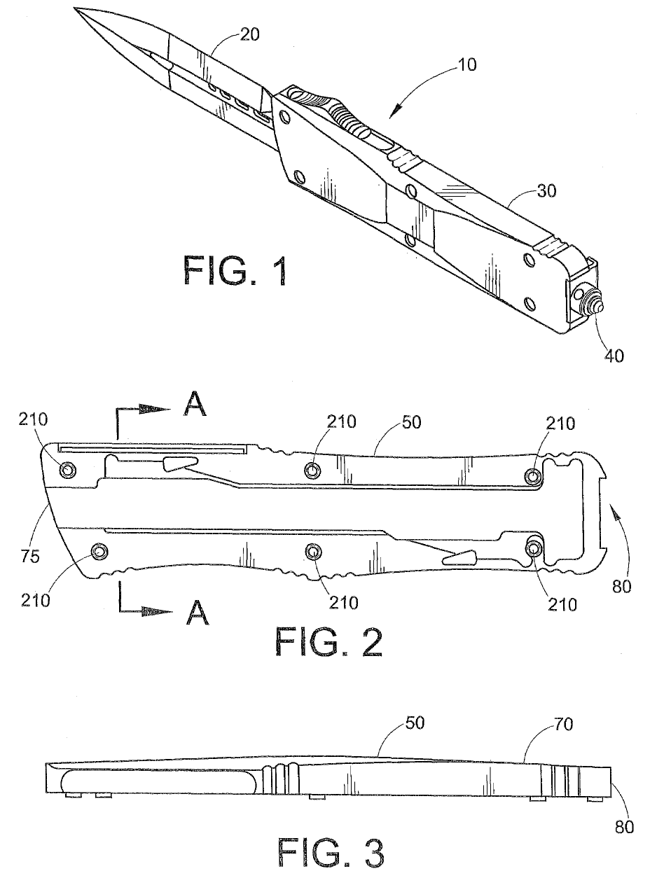

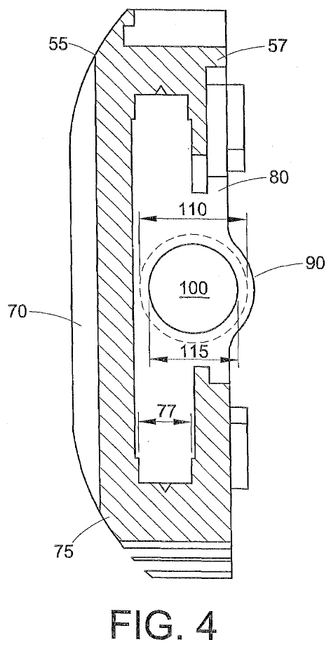

FIGS. 2-4 are various views of the frame of the exemplary embodiment of FIG. 1. The handle 30 comprises a frame 50 and a cover 60. The handle frame 50 comprises a handle sidewall 70 and a second wall 80. The second wall 80 is generally perpendicular to the sidewall 70. The second wall 80 has an arch 90 which extends away from the sidewall 70. A threaded bore 100 runs through the second wall 80 and is at least partially located within the arch 90 (see FIG. 4).

FIG. 4 is a cross-sectional view of the frame 50 looking towards the rear of the knife from line A-A shown in FIG. 2. Reference numeral 75 refers to the front end of the knife. The frame 50 has a rectangular cutout of width 77 within which the blade 20 extends in and out of the handle 30. The frame 50 also comprises an outer edge 55 and an inner face 57. The inner face 57 is substantially planar. The threaded bore 100 has a bore diameter 115 which extends beyond the inner face 57; this is what is meant when it is said that the threaded bore 100 is located within the arch 90.

The threaded bore 100 has a bore thread diameter 110 which corresponds to the diameter 160 of the threaded stud 45 located on the window breaker 40 (see FIG. 11). Both the bore thread diameter 110 and the threaded stud diameter 160 include the width of the threads themselves. The threaded bore 100 also has a bore diameter 115 which does not include the threads, i.e. the bore diameter 115 is always less than the bore thread diameter 110. Generally, the bore diameter 115 is the diameter that is visible from the rear (see FIG. 7). The bore diameter 115 is shown in FIG. 4 as a solid circle and the bore thread diameter 110 is shown as a dotted circle.

In some specific embodiments, the bore diameter 115 may be from about 0.120 inches to about 0.150 inches. In an exemplary embodiment, the bore diameter 115 is about 0.134 inches.

The bore thread diameter 110 is sufficiently large that the structural integrity of the arch 90 is compromised. This phrase “the structural integrity of the arch is compromised” means that the arch might crack or break if the window breaker 40 was screwed into the bore 100 and used to break a window without the cover 60 being used to reinforce the arch 90. In specific embodiments, the bore thread diameter 110 may be from about 0.180 inches to about 0.200 inches. In an exemplary embodiment, the bore thread diameter is about 0.190 inches. This bore, when threaded, accommodates a 10-32 threaded fastener.

Alternatively, the second wall has a width 85 measured from the outer edge 55 of the frame 50 to the farthest point 96 of the arch 90 from the outer edge 55 (see FIG. 10). The ratio of the bore diameter 115 to the second wall width 85 may be from about 0.55 to about 0.65. In specific embodiments, the ratio of the bore diameter to the second wall width is from about 0.60 to about 0.65 and in an exemplary embodiment, the ratio is about 0.62.

Alternatively, the arch has an arch width 92 and the second wall 85 has a base width 94 (see FIG. 10). The arch width 92 runs from the farthest point 96 of the arch to the circumference of the threaded bore 100 furthest from the outer edge 55 of the frame 50. The base width 94 runs from the outer edge 55 to the circumference of the threaded bore 100 closest to the outer edge 55 of the frame 50. In otherwords, the second wall width 85 is equal to the sum of the arch width 92, bore diameter 115, and base width 94. The ratio of the arch width 92 to the base width 94 is from about 0.40 to about 0.70. In an exemplary embodiment, the ratio of the arch width to the base width is about 0.65.

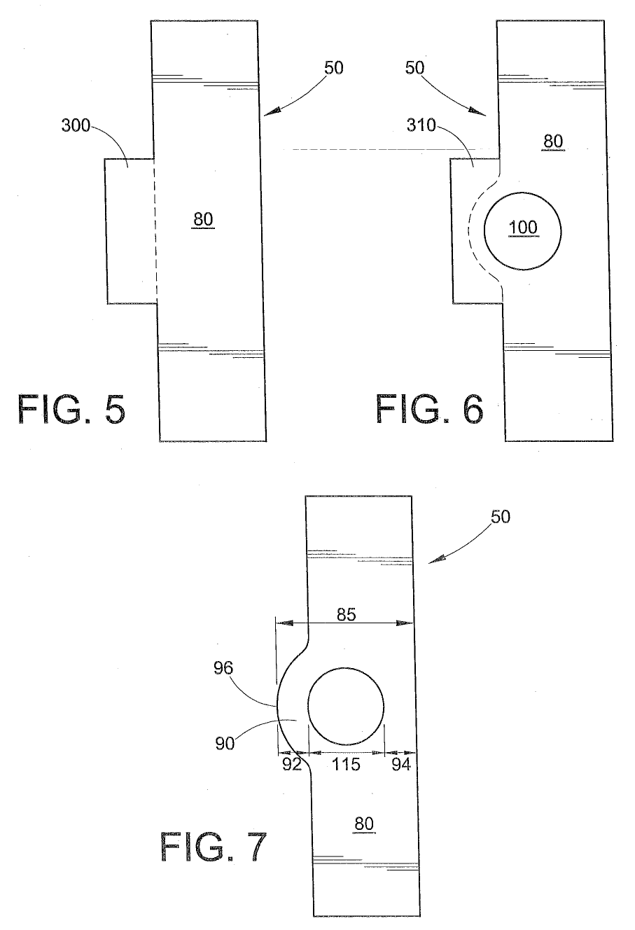

FIGS. 5-7 show how the arch 90 can be made. The arch 90 can be formed on the frame handle 50 by providing an enlarged portion 300 on the second wall 80 of the frame 50 which is larger than the finished arch 90 will be (see FIG. 5). The enlarged portion 300 is located along the second wall 80 adjacent to the desired location for the threaded bore 100. The threaded bore 100 is then formed in the second wall 80, for example by drilling and tapping, such that the threaded bore is at least partially located within the enlarged portion 300. The enlarged portion 300 provides strength during this process because it is thick enough so that drilling does not break it off the frame 50. After the threaded bore 100 is formed, an undesired portion 310 of the enlarged portion 300 remains attached to the second wall 80 (see FIG. 6). The undesired portion 310 is removed by machining to form the arch 90 (see FIG. 7).

Alternatively, the frame is machined to have the outer shape seen in FIG. 7. The frame is then restrained in a tool fitting closely along both the flat outer edge 55 and the side including the arch. The threaded bore 100 is then formed in the second wall 80 as described above.

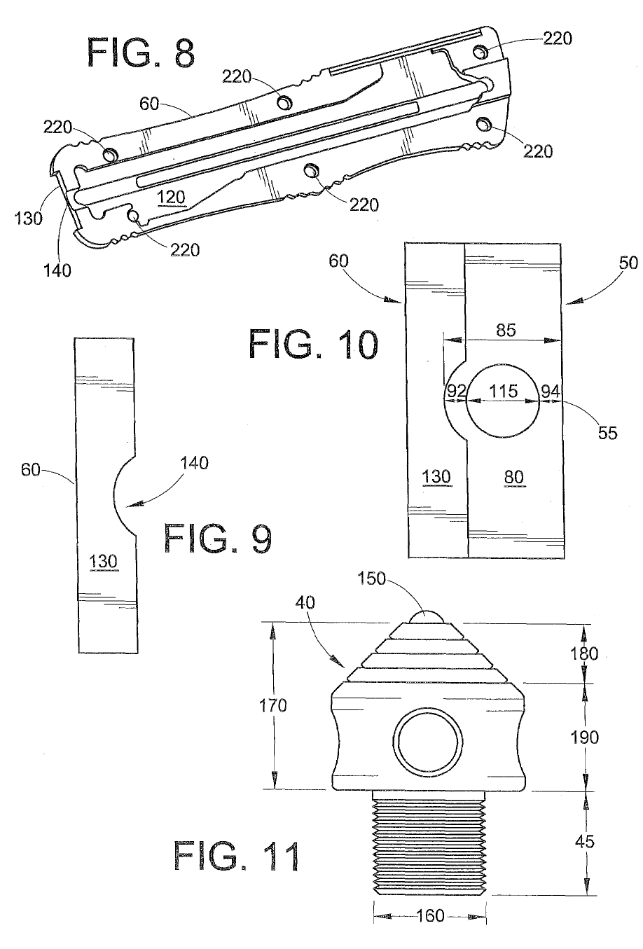

FIG. 8 is a side view of the handle cover. FIG. 9 is a rear view of the handle cover. The handle cover 60 comprises a cover sidewall 120 and a support wall 130. The support wall 130 is generally perpendicular to the cover sidewall 120. The support wall 130 has a recess 140 which is shaped to precisely fit the arch 90 of the handle frame 50 (see FIG. 9).

FIG. 10 is a rear view of the handle. When the frame 50 and cover 60 are assembled together to form the handle 30, the recess 140 provides additional support to the arch 90. The window breaker 40 can thus be screwed into the handle 30 and used without compromising the structural integrity of the arch 90.

FIG. 11 is a view of the window breaker. The window breaker 40 comprises a tip 150 and a threaded stud 45, The tip 150 is the portion of the window breaker 40 that actually contacts the window. The tip 150 is generally a material that is harder than glass, such as carbide. The threaded stud 45, as previously described, has a diameter 160 which is about equal to that of the bore diameter 110. In the depicted window breaker 40, the tip 150 and the threaded stud 45 are connected to each other by a window breaker body 170. The body 170 comprises two portions 180 and 190. The tip 150 is fitted into a conical frustum portion 180. The conical frustum 180 is connected to a cylinder portion 190. The depicted cylinder portion 190 has a cross hole 200 through it; this may be provided, for example, to put a lanyard through for easy carrying of the knife 10. The tip 150, body 170, and threaded stud 45, are all aligned along a common axis.

In a specific embodiment, the window breaker 40 has a threaded stud diameter 160 of about 0.160 inches. The frame 50 therefore has a bore thread diameter 110 of about 0.160 inches. Because the thread has a width of about 0.028 inches, the bore diameter 110 is about 0.134 inches. The arch 90 has an arch width 92 of about 0.043 inches and the base width 94 is about 0.067 inches. The second wall width 85 is about 0.216 inches.

The handle design of the knife of the present disclosure is useful in all knives, but especially in knives having thin handles. In specific embodiments, the handle of the knife is at most 1.0 inch thick. As the thickness of the handle decreases, its ability to support the window breaker decreases as well. In further embodiments, the handle of the knife is at most 0.5 inches thick. In certain specific embodiments, the handle of the knife is about 0.43 inches thick.

The window breaker is generally located on the rear end of the knife handle. However, in other embodiments, the window breaker may be located on other sides of the knife which are not the sidewall. For example, in a folding knife, it may be desired to place the window breaker on the top of the knife, the side of the knife opposite the side where the blade enters its sheathed position inside the handle.

The knife 10 comprises a blade 20 as known in the art. The knife 10 may further comprise a blade locking system (not shown) to prevent the blade from moving between the safety position and the use position unless desired by the user. Any blade locking system may be used. A suitable blade locking system is described in a copending application (MKIE-200019) entitled “FIELD STRIPPABLE KNIFE”. The frame 50 and cover 60 may further comprise a fastener system to attach the frame and cover together. For example, the frame depicted in FIG. 2 has six threaded bores 210 and the cover of FIG. 5 has six holes 220. When the frame and cover are assembled, six bolts (not shown) may be threaded through the holes 220 and into the bores 210 to hold the frame and cover together.

The knife having a window breaker of the present disclosure has been described with reference to various exemplary embodiments. Obviously, modifications and alterations will occur to others upon reading and understanding the preceding detailed description. It is intended that the knife of the present disclosure be construed as including all such modifications and alterations insofar as they come within the scope of the appended claims or the equivalents thereof.

1. A knife with a window breaker, comprising:
a blade; and
a thin handle comprising a frame and a cover;
the frame comprising a sidewall and a second wall, the second wall having an arch extending away from the sidewall, and a threaded bore running through the second wall and at least partially located within the arch;
the cover comprising a sidewall and a support wall having a recess into which the arch fits; and
a window breaker comprising a tip and a threaded stud, wherein the threaded stud fits in the threaded bore.

2. The knife of claim 1, wherein the second wall of the frame forms the rear end of the handle.

3. The knife of claim 1, wherein the handle is at most 1.0 inch thick.

4. The knife of claim 1, wherein the threaded bore has a diameter, not including the threads, of from about 0.120 inches to about 0.150 inches.

5. The knife of claim 4, wherein the threaded bore has a diameter, not including the threads, of about 0.134 inches.

6. The knife of claim 1, wherein the threaded bore has a diameter, including the threads, of from about 0.180 inches to about 0.200 inches.

7. The knife of claim 6, wherein the threaded bore has a diameter, including the threads, of about 0.190 inches.

8. The knife of claim 1, wherein the second wall has a second wall width, the threaded bore has a bore diameter which does not include the width of the threads, and the ratio of the bore diameter to the second wall width is from about 0.55 to about 0.65.

9. The knife of claim 8, wherein the ratio of the bore diameter to the second wall width is from about 0.62.

10. The knife of claim 1, wherein the second wall has a base width measured from an outer edge of the frame to the point of the threaded bore closest to the outer edge;
wherein the second wall has an arch width measured from a farthest point of the arch which is furthest from the outer edge of the frame to the point of the threaded bore closest to the farthest point; and
wherein the ratio of the arch width to the base width is from about 0.40 to about 0.70.

11. The knife of claim 10, wherein the ratio of the arch width to the base width is about 0.65.

12. The knife of claim 1, wherein the knife is a slide knife.

13. The knife of claim 1, wherein the knife is a folding knife.

14. The knife of claim 1, wherein the knife further comprises a blade locking system.

15. The knife of claim 1, further comprising a fastener system to attach the frame and the cover together.

16. A knife with a window breaker, comprising:
a blade; and
a handle comprising a frame and a cover;
the frame comprising a sidewall, a second wall, and a threaded bore running through the second wall;
the cover comprising a sidewall and a support wall that interfaces with the second wall; and
a window breaker comprising a tip and a threaded stud, wherein the threaded stud fits in the threaded bore;
wherein the bore has a diameter sufficiently large such that the structural integrity of the arch is compromised without support from the support wall.

17. The knife of claim 16, wherein the handle is at most 0.50 inches thick.

18. The knife of claim 16, wherein the second wall has a second wall width, the threaded bore has a bore diameter which does not include the width of the threads, and the ratio of the bore diameter to the second wall width is from about 0.55 to about 0.65.

19. The knife of claim 18, wherein the ratio of the bore diameter to the second wall width is from about 0.62.

20. The knife of claim 16, wherein the threaded bore has a diameter, including the threads, of about 0.190 inches.

21. A method for forming a thin arch on a wall of a knife handle frame, comprising:
providing a knife handle frame having a wall and an enlarged portion on the wall;
forming a threaded bore in the wall such that the threaded bore is at least partially located within the enlarged portion; and
removing an undesired portion of the enlarged portion to form a thin arch on the wall of the knife handle frame.

22. A method for forming a thin arch on a wall of a knife handle frame, comprising:
providing a knife handle frame having an outer edge, a wall and an enlarged portion on the wall;
machining an outer edge of the enlarged portion to form an arch;
restraining the knife handle frame in a tool fitting which closely fits the arch and the outer edge of the handle frame; and
forming a threaded bore in the wall such that the threaded bore is at least partially located within the arch.
